(19) United States
(12) Patent Application Publication
(10) Pub. No.: US 2008/0199379 A1
(43) Pub. Date: Aug. 21, 2008

(54) Method and Device For Removing Sulphur Dioxide From a Dry Gas Stream

(75) Inventors: Thomas Bogenstatter, Bad Durkheim (DE); Wolfgang Gmeiner, Dannstadt-Schauernheim (DE); Volker Fattinger, Arlesheim (CH); Walter Jaeger, Engelskirchen (DE)

Correspondence Address: CONNOLLY BOVE LODGE & HUTZ LLP, 1875 EYE STREET, N.W., SUITE 1100, WASHINGTON, DC, 20036, US

(73) Assignee: BASF SE, Ludwigshafen (DE)

(21) Appl. No.: 12/065,389

(22) PCT Filed: Aug. 28, 2006
(86) PCT No.: PCT/EP2006/065731

§ 371 Date: Feb. 29, 2008

(30) Foreign Application Priority Data
Sep. 2, 2005 (DE) 10 2005 041 794.9

(51) Int. Cl. B01D 53/50; B01J 19/00

(52) U.S. Cl. 423/243.01; 423/242.1; 422/168

(57) ABSTRACT

The invention relates to a method for removing sulfur dioxide from a dry gas stream which comprises following steps:
(a) adding a hydrogen-peroxide-comprising liquid to the gas stream, sulfuric acid forming from the hydrogen peroxide and the sulfur dioxide and
(b) condensing, absorbing or aerosol precipitation of the sulfuric acid formed.

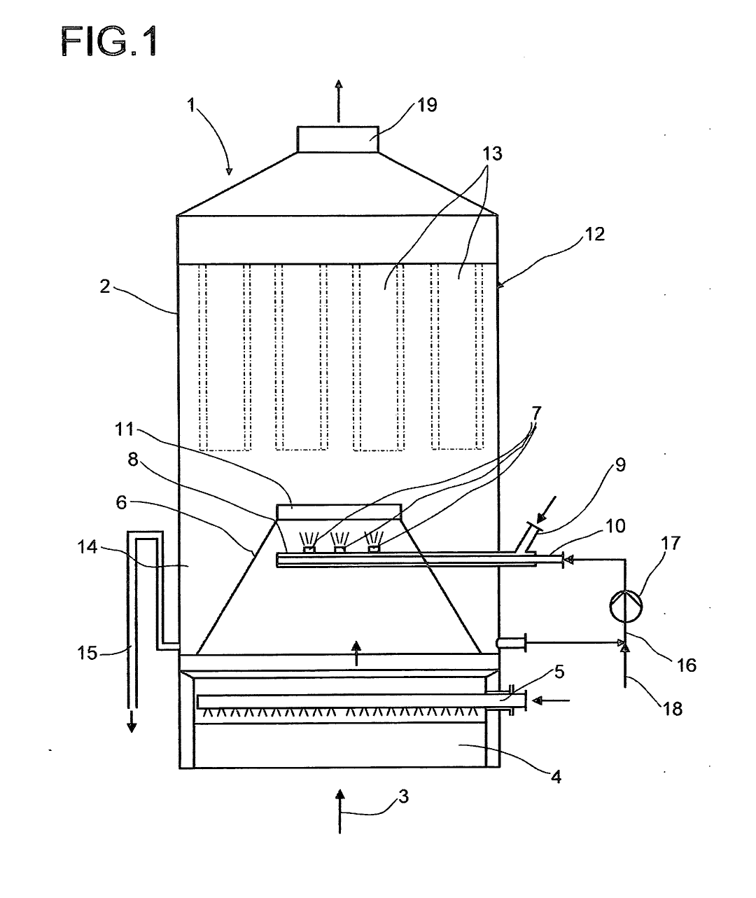

The admixed hydrogen-peroxide-comprising liquid is mixed with the dry gas stream in the course of less than 0.3 s in such a manner that the admixed liquid is essentially homogeneously distributed in the gas stream. Furthermore, the invention relates to an apparatus for removing sulfur dioxide from a dry gas stream which comprises at least one atomizing nozzle for adding the hydrogen-peroxide-comprising liquid and a filter or aerosol separator, arranged downstream, in the direction of flow of the gas stream, of the at least one atomizing nozzle, in each case at least one atomizing nozzle being arranged on a cross sectional area of 300 to 350 cm².

The invention relates to a method for removing sulfur dioxide from a dry gas stream. In addition, the invention relates to an apparatus for carrying out the method.

It is necessary to remove sulfur dioxide from dry gas streams, since the legislature is laying down increasingly higher requirements for permissible sulfur dioxide (SO₂) and sulfur trioxide (SO₃) emissions in gas streams which are released to the environment.

SO₃ is currently removed, e.g., by absorption using approximately 98 percent strength sulfuric acid. Sulfuric acid aerosols entrained by the gas stream can be removed from the gas stream using a filter. Use is generally made of candle filters which consist of individual candles.

The SO₂ present in the gas stream, however, is not absorbed by the sulfuric acid. For this reason, the SO₂ must be removed from the gas stream by a different method. A known method for removing SO₂ is chemical absorption in a hydrogen peroxide (H₂O₂) solution of a concentration in the range from 10 to 40 g of H₂O₂/l. Such a chemical absorption is described, e.g., in VDI Berichte No. 730, 1989, pages 331 to 347. In this case the SO₂-comprising crude gas is brought into contact with the H₂O₂-Comprising scrubbing solution in a two-stage randomly packed scrubber. The two-stage randomly packed scrubber is operated in countercurrent flow and has two separate liquid circuits. The crude gas enters in the lower part of the scrubber. The H₂O₂-comprising solution is mixed with a sulfuric acid liquid circulated stream to form an H₂O₂-comprising scrubbing solution and applied by a trickling system to an upper random packing. The H₂O₂-comprising scrubbing solution having the SO₂ absorbed therein and exhaustively reacted to H₂SO₄ runs into an intermediate sump. From the intermediate sump, the H₂O₂-comprising scrubbing solution is taken off as sulfuric acid liquid circulated stream, again mixed with the H₂O₂-comprising solution and applied to the upper random packing. The solution dripping from the upper random packing, in addition to sulfuric acid, also comprises incompletely reacted H₂O₂. From the intermediate sump, a part of the solution runs into the lower part of the scrubber and there drips onto the lower random packing. Here, the remaining H₂O₂ reacts with the sulfur dioxide from the crude gas to form sulfuric acid. The liquid running through the lower random packing is collected in a sump. From the sump, clean sulfuric acid is taken off. A part of the sulfuric acid is applied to the lower random packing in a liquid circuit. The crude gas thus purified only still comprises amounts of sulfur dioxide which are so low that the gas can be released to the environment.

A further possible method known from the prior art of removing sulfur dioxide from dry gas streams is to pass the gas stream through a catalyst bed. In the presence of the catalyst, the sulfur dioxide is oxidized to form sulfur trioxide. The resultant sulfur trioxide can be scrubbed from the gas stream by sulfuric acid. In this case, however, an SO₂ content is not reached which is in the range of less than 50 to 100 ppm.

Sulfur-dioxide-comprising exhaust gases occur, e.g., in the production of sulfuric acid from sulfur. In this case, sulfur is first oxidized to sulfur dioxide. The sulfur dioxide is oxidized in a further step to sulfur trioxide. The sulfur trioxide is absorbed in sulfuric acid. The acid concentration is set via addition of water. The sulfur dioxide conversion rate in this method is approximately 99.5 to 99.8 percent. Unreacted SO₂ is released to the environment. Such a method for producing sulfuric acid is described, e.g. in Schwefel Schwefeldioxid Schwefelsäure [Sulfur sulfur dioxide sulfuric acid], reprint from Ullmann Enzyklopädie der technischen Chemie [Ullmann's Encyclopedia of Industrial Chemistry] for the Lurgi companies, 1982.

It is an object of the present invention to provide an alternative method for reducing the SO₂ emissions.

The object is achieved by a method for removing sulfur dioxide from a dry gas stream which comprises the following steps:
(a) adding a hydrogen-peroxide-comprising liquid to the gas stream, sulfuric acid forming from the hydrogen peroxide and the sulfur dioxide and
(b) condensing, absorbing or aerosol precipitation of the sulfuric acid formed,
   which comprises the admixed hydrogen-peroxide-comprising liquid being mixed with the dry gas stream in the course of less than 0.3 s in such a manner that the injected liquid is essentially homogeneously distributed in the gas stream.

“Essentially homogeneously distributed” means here that the amount of the injected liquid in the gas stream deviates by a maximum of 10 percent from a mean concentration at any point over the flow cross-sectional area.

In a preferred embodiment, the admixed hydrogen-peroxide-comprising liquid is mixed with the dry gas stream in the course of less than 0.03 s in such a manner that the admixed liquid is essentially homogeneously distributed in the gas stream.

The sulfur-dioxide-comprising dry gas stream can originate, for example, from a pure sulfur combustion, combustion of sulfurous substances, or the roasting of sulfurous ores. Preferably, the inventive method, however, is applied to gas streams which originate from the production of sulfuric acid.

The SO₂ present in the gas stream is customarily oxidized to SO₃ in the presence of a catalyst and then absorbed as H₂SO₄ or oleum. The inventive method is preferably applied to gas streams which have an SO₂ concentration of less than 1% by volume to reduce the emissions in the exhaust gas stream.

The hydrogen-peroxide-comprising liquid which is added to the gas stream generally comprises up to 60% by weight of hydrogen peroxide, preferably the admixed liquid comprises 20 to 60% by weight of hydrogen peroxide.

The temperature of the dry gas stream is preferably high enough so that the added liquid at least partially evaporates in the gas stream. Preferably, the temperature of the gas stream is in the range from 20 to 140° C., preferably in the range from 30° C. to 140° C.

In a preferred embodiment sulfuric acid is additionally added to the gas stream. The added sulfuric acid is preferably at least 90% pure, more preferably at least 95% pure, and in particular at least 98% pure. The sulfuric acid can either be present in the added liquid additionally to the hydrogen peroxide, or added separately therefrom to the gas stream. If the sulfuric acid is present in the hydrogen-peroxide-comprising liquid, the sulfuric acid is preferably not added until immediately before adding the liquid to the gas stream.

Rapid and homogeneous distribution of the liquid in the gas stream is preferably achieved by the liquid being sprayed into the gas stream via atomizing nozzles. Rapid mixing of the liquid with the gas stream in the course of less than 0.3 s is required, so that the hydrogen peroxide does not decompose before it reacts with the sulfur dioxide.

In the case of separate addition of the hydrogen-peroxide-containing liquid, and the sulfuric acid, the sulfuric acid is also preferably sprayed into the gas stream via atomizing nozzles.

A suitable atomizing nozzle is any nozzle form known to those skilled in the art. The atomization is performed either due to high velocity of the liquid to be atomized, the high velocity being generated, e.g., by a corresponding cross sectional area constriction of the nozzle, or else via rapidly rotating nozzle components. Such nozzles having rapidly rotating nozzle components are, for example, high-speed rotary bells. A further possibility for atomizing the liquid is passing in addition to the liquid a gas stream through the atomizing nozzle. The liquid is entrained by the gas stream and as a result atomized into fine droplets. For very fine atomization, suitable nozzles are, in particular, atomizing nozzles in which the liquid is atomized by a gas stream, or nozzles having a relatively small bore which require a correspondingly high liquid pressure.

If the sulfuric acid and the hydrogen-peroxide-comprising liquid are added separately to the gas stream, the atomizing nozzles are preferably arranged in such a manner that the spray cones mix with one another. Preferably, the atomizing nozzles are arranged in such a manner that the atomizing nozzles which add the sulfuric acid alternate with the atomizing nozzles which add the hydrogen-peroxide-comprising liquid.

Generally, all atomizing nozzles are arranged in one plane. However, it is also possible to arrange, e.g. the atomizing nozzles which add the hydrogen-peroxide-comprising liquid in one plane, and to arrange the atomizing nozzles which add the sulfuric acid in a further plane offset from the first plane. The atomizing nozzles are preferably arranged in a ring shape, in which case the distance between two atomizing nozzles should generally not be greater than approximately 20 cm. Thus at least one atomizing nozzle is arranged on a flow cross-sectional area of less than 320 cm². In addition to the ring-shaped arrangement of the atomizing nozzles, any other desired ordered or non-ordered arrangement of the atomizing nozzles is also conceivable. However, it is also necessary here to ensure that the distance between two atomizing nozzles does not exceed approximately 20 cm, so that even in the case of atomizing nozzles not arranged in a ring shape, in each case at least one atomizing nozzle is arranged on a flow cross-sectional area of 300 to 350 cm².

Virtually complete reaction of the sulfur dioxide present in the gas stream is achieved by the means that the amount of the added hydrogen peroxide preferably corresponds to 1.0 to 2.5 times the stoichiometrically required amount for reaction of all of the sulfur dioxide present in the gas stream. A virtually complete reaction means that the sulfur dioxide content in the gas stream after the reaction is a maximum of 200 ppm, preferably a maximum of 100 ppm.

The sulfuric acid formed in the reaction of the sulfur dioxide with the hydrogen peroxide condenses out in the gas stream. As a result, droplets form which can then be separated off from the gas stream. They are separated off, e.g. using a filter, or an aerosol separator. A suitable filter is any filter using which aerosol droplets can be separated off from a gas stream. Preferred filters are candle filters which comprise adjacently arranged filter candles. The filter is preferably selected in such a manner that it has at least a separation efficiency of 100% for particles having a particle size of at least 3 μm, and of greater than 95% for particles having a particle size of greater than 1 μm. Suitable filters are, for example, those which in accordance with the manufacturer's data, have a separation efficiency of 100% for particles having a particle size of greater than 1 μm, and 98% for particles having a particle size of greater than 0.5 μm. A further suitable filter has, according to manufacturer's data, e.g. a separation efficiency of 100% for particles having a particle size of greater than 3 μm, and a separation efficiency of 95% for particles having a particle size of greater than 1 μm. A suitable material for the filters is any material which is stable to the temperatures occurring and which is not attacked by the resultant sulfuric acid. Preferred materials are, for example, glass wool, polypropylene, or polyester fibers. Particularly preferred for the separation of sulfuric acid is glass wool.

In addition to the filter, customary aerosol separators known to those skilled in the art can also be used for separating off the sulfuric acid. Such aerosol separators are, e.g., loop-formingly knitted or loop-drawingly knitted fabrics. Also, as aerosol separator, use can be made of random packings having liquid circulation in a similar manner to H₂SO₄ absorbers. A suitable liquid for the liquid circulation is, for example, sulfuric acid. These aerosol separators must also be fabricated from a material which is stable to the temperatures occurring and which is not attacked by sulfuric acid.

To achieve an improved mixture of the gas stream with the hydrogen-peroxide-comprising liquid, the gas stream, after addition of the hydrogen-peroxide-comprising liquid, is, in a preferred embodiment, passed through a turbulence generator. A suitable turbulence generator here is any turbulence generator known to those skilled in the art, e.g. channel-wall-mounted fins or rods which are arranged at any desired angle transversely to the direction of flow of the gas, irregular loop-formingly or loop-drawingly knitted fabrics, or any desired commercially conventional turbulators. Preferred turbulence generators are loop-drawingly knitted fabrics made of glass fiber.

In a further embodiment, the sulfur-dioxide-comprising dry gas stream, upstream of the addition of the hydrogen-peroxide-comprising liquid, is passed over an absorber packing. In the absorber packing, generally, sulfur trioxide likewise present in the gas stream is removed from the gas stream. The sulfur trioxide is removed by absorption in sulfuric acid. For this, sulfuric acid is trickled over the absorber packing in such a manner that a sulfuric acid film forms on the individual packing elements. A suitable packing is, e.g., a structured packing or a random packing. A suitable material for the structured packing or the random packing is any material which is stable to the temperatures occurring and is not decomposed by sulfuric acid. A preferred material for the structured packing or the random packing is ceramic.

In addition to the arrangement of the absorber packing upstream of the feed point of the hydrogen-peroxide-comprising liquid, it is also possible first to add the hydrogen-peroxide-comprising liquid to the gas stream, and then to pass the gas stream over the absorber packing.

A further improvement of the mixing of the added hydrogen-peroxide-comprising liquid in the gas stream can be achieved by the means that the velocity of the gas stream is increased upstream of the addition of the hydrogen-peroxide-comprising liquid. The increase of the velocity of the gas stream is preferably generated by a constriction of the flow cross-sectional area. The constriction of the flow cross-sectional area can be implemented continuously or in the form of a sudden cross sectional constriction. Preference here is given to a continuous constriction of the flow cross-sectional area. A Venturi tube, e.g., has a suitable geometry in which the velocity is increased appropriately. If, in addition to the cross-sectional constriction, a turbulence generator is used, it is preferably arranged in the narrowest cross section.

The invention further relates to an apparatus for removing sulfur dioxide from a dry gas stream according to the above-described method. The apparatus comprises at least one atomizing nozzle for adding the hydrogen-peroxide-comprising liquid, and a filter or aerosol separator, arranged downstream, in the direction of flow of the gas stream, of the at least one atomizing nozzle, in each case at least one atomizing nozzle being arranged on a cross-sectional area of 315.16 cm². The inventive apparatus is preferably arranged downstream, in the direction of flow of the gas, of an absorber packing, in which, if appropriate, sulfur trioxide present in the gas is scrubbed out. In the region of the gas inlet, in the apparatus constructed according to the invention, a truncated-cone-shaped section is arranged. In the truncated-cone-shaped section, the flow cross-sectional area of the gas constricts, as a result of which the flow velocity is increased.

In a preferred embodiment, the at least one atomizing nozzle using which the hydrogen-peroxide-comprising liquid is added to the gas stream is situated in the region of the narrowest cross section of the truncated-cone-shaped insert.

In a preferred embodiment, the inventive apparatus is designed in such a manner that the flow cross-sectional area in the region of the at least one atomizing nozzle is smaller than the flow cross-sectional area at the gas inlet point. Particularly preferably, the flow cross-sectional area decreases continuously in the direction of flow from the gas inlet point up to the atomizing nozzle. The continuous decrease in the flow cross-sectional area ensures that no pole points are situated in the gas stream at which vortexes form where no gas exchange proceeds.

Preferably, the hydrogen-peroxide-comprising liquid is added upstream of the region of the narrowest cross section. The further decrease in sectional area downstream of the addition of the hydrogen-peroxide-comprising liquid further increases the velocity of the gas stream and as a result the mixing improves. In addition, it is possible to connect, downstream of the at least one atomizing nozzle, a turbulence generator, which increases the turbulence of the gas stream, as a result of which, likewise, the mixing of gas stream and hydrogen-peroxide-comprising liquid is improved. In a preferred embodiment, the turbulence generator is arranged in the region of the smallest cross sectional area in the direction of flow upstream of the filter or aerosol separator.

The apparatus is preferably constructed in such a manner that the flow cross-sectional area, downstream of the addition of the hydrogen-peroxide-comprising liquid, increases continuously or in the form of a sudden expansion, before the gas stream reaches the filter or aerosol separator. The increase in the flow cross-sectional area decreases the velocity of the gas stream and simultaneously increases the turbulence. As a result of the increased turbulence, mixing of liquid and gas is improved. The decrease in the flow velocity avoids sulfuric acid being released from the apparatus via drop entrainment from the filter or aerosol separator.

The invention will be described in more detail hereinafter with reference to a drawing.

The single FIGURE shows an apparatus constructed according to the invention for removing sulfur dioxide from a dry gas stream.

An apparatus 1 for removing sulfur dioxide from dry gas streams comprises a housing 2 in which the gas stream flows.

In the embodiment shown in the FIGURE, the gas stream, the direction of flow of which is shown by an arrow 3 first flows through an absorber packing 4. In the absorber packing 4, if appropriate sulfur trioxide present in the gas stream is scrubbed out using sulfuric acid. For this, the sulfuric acid is fed via a sulfuric acid feed line 5 in which outlet orifices on the side facing the absorber packing 4 are situated. In addition to the embodiment shown here in which the sulfuric acid is fed via orifices in the sulfuric acid feed line 5, it is also possible to distribute the sulfuric acid on the absorber packing, for example by means of atomizing nozzles. Any other possible method known to those skilled in the art for feeding sulfuric acid is also conceivable.

After the gas stream has passed through the absorber packing, it enters the apparatus i for removing sulfur dioxide. In the entry region there is constructed a truncated-cone-shaped section 6 through which the gas stream flows. The truncated-cone-shaped section 6 is arranged in such a manner that the flow cross-sectional area decreases during flow through the truncated-cone-shaped section 6. As a result of the decrease of the flow cross-sectional area, the velocity of the gas increases.

Atomizing nozzles 7 are arranged in the truncated-cone-shaped section 6. The atomizing nozzles are preferably situated on a ring line 8. A hydrogen-peroxide-comprising liquid is fed via the ring line 8 to the atomizing nozzles 7. The hydrogen-peroxide-comprising liquid is added to the gas stream via the atomizing nozzles 7. In the case of the embodiment shown here, the hydrogen-peroxide-comprising liquid is fed to the ring line 8 via a feed 9. In addition, via a second feed 10, sulfuric acid can be added to the ring line which is likewise added to the gas stream via the atomizing nozzles 7. After the hydrogen-peroxide-comprising liquid and, if appropriate, the sulfuric acid, are added to the gas stream, it flows through a turbulence generator 11. The turbulence generator 11 increases the turbulence in the gas stream and thus improves the mixing of the gas stream with the added liquid. Downstream of the turbulence generator 11 in the direction of flow, the truncated-cone-shaped section 6 which is accommodated in the housing 2 ends, as a result of which the cross-sectional area increases. This reinforces the turbulence and thus additional mixing of the gas with the liquid present therein is achieved. In addition, as a result of the cross-sectional area enlargement, the flow velocity of the gas decreases.

A filter 12 is arranged above the turbulence generator 11. In the filter 12, sulfuric acid, which is present as aerosol droplets in the gas stream, is separated off. The sulfuric acid is formed first by reaction of the sulfur dioxide with the hydrogen peroxide, secondly, sulfuric acid added to the gas stream via the atomizing nozzles 7 and also present therein as aerosol entrained by the gas stream from the absorber packing 4. In the embodiment shown in the FIGURE, the filter 12 is a candle filter. This comprises a plurality of filter candles 13. However, instead of the candle filter, use can be made of any other desired filter known to those skilled in the art by which drops may be separated off from a gas stream. Instead of the filter 12, an aerosol separator can also be used.

The sulfuric acid separated off from the gas stream by filter 12 drips from filter 12 and is collected in a sulfuric acid pool 14 which surrounds the truncated-cone-shaped section 6. A portion of the sulfuric acid present in the sulfuric acid pool 14 is taken off via an outlet 15. Another portion of the sulfuric acid is fed via a line 16 in which is situated a pump 17, fed to the second feed 10 and then sprayed into the gas stream via the ring line 8 and the atomizing nozzles. Via a sulfuric acid feed 18 which opens out into the line 16, if necessary, further sulfuric acid can be supplemented.

The gas stream purified from sulfur dioxide, after separating off the sulfuric acid, flows out of the apparatus 1 via an outlet orifice 19 and can be released to the environment, e.g. via a stack.

### EXAMPLES

### COMPARATIVE EXAMPLE

A compressed-air atomizing nozzle was inserted into a gas line having a diameter of 1400 mm. Via the compressed-air atomizing nozzle, an aqueous hydrogen peroxide solution having a hydrogen peroxide content of 30% by weight was sprayed into the gas line. 50 000 m³/h of process gas at a temperature of about 50° C. flowed through the gas line. The process gas was composed of 2075 kmol/h of N₂, 134 kmol/h of O₂, 0.39 kmol/h of SO₂ and less than 60 mg/Nm³ SO₃. The amount of aqueous hydrogen peroxide solution fed via the compressed-air atomizing nozzle was 50 l/h.

No reduction of the sulfur dioxide emission in the exhaust gas was observed.

### Example 1

In a Venturi tube having an internal diameter of 150 mm on a length of 500 mm which conically tapered over a length of 200 mm to an internal diameter of 50 mm and then, over a length of 400 mm, expanded back to an internal diameter of 150 mm, and from the outlet a 1300 mm long section having a diameter of 150 mm connects thereto, just upstream of the point at which the diameter of the tube decreases, an air atomizing nozzle having a nozzle diameter (bore) of 0.4 mm was arranged. Via the air atomizing nozzle, an aqueous hydrogen peroxide solution having a content of 30% by weight of hydrogen peroxide was sprayed into the gas stream. Through the Venturi tube, approximately 100 m³/h of a dry gas stream which comprised 580 mg of SO₂/Nm³ flowed. The temperature of the gas stream was approximately 50° C. The rate of the added aqueous hydrogen peroxide solution was 100 ml/h. In the region of the narrowest cross section, steel wool was inserted as turbulence generator. At the end of the Venturi tube, a sulfur dioxide content of 380 mg of SO₂/Nm³ was measured. In the course of the experiment, the SO₂ content decreased continuously. After 6 hours, a sulfur dioxide content of 230 mg of SO₂/Nm³ was measured.

### Example 2

An experiment was carried out under the same conditions as in example 1, but 180 ml/h of aqueous hydrogen peroxide solution were added and the fraction of SO₂ in the gas stream was 480 mg/Nm³. At the start of the experiment, at the end of the Venturi tube a sulfur dioxide content of 208 mg of SO₂/Nm³ was measured; after an experimental period of 6 hours, the sulfur dioxide content was below the limit of detection.

### LIST OF DESIGNATIONS

1 Apparatus
2 Housing
3 Direction of flow of the gas
4 Absorber packing
5 Sulfuric acid feed line
6 Truncated-cone-shaped section
7 Atomizing nozzles
8 Ring line
9 Feed
10 Second feed
11 Turbulence generator
12 Filter
13 Filter candle
14 Sulfuric acid pool
15 Outlet
16 Line
17 Pump
18 Sulfuric acid feed
19 Outlet orifice

1-20. (canceled)

21. A method for removing sulfur dioxide from a dry gas stream which comprises:
(a) adding a hydrogen-peroxide-comprising liquid to the gas stream, sulfuric acid forming from the hydrogen peroxide and the sulfur dioxide; and
(b) condensing, absorbing or aerosol precipitation of the sulfuric acid formed, wherein the hydrogen-peroxide-comprising liquid, and if appropriate the sulfuric acid, are sprayed into the gas stream via atomizing nozzles, at least one atomizing nozzle being arranged on a flow cross-sectional area of 300 to 350 cm² the admixed hydrogen-peroxide-comprising liquid is mixed with the dry gas stream in the course of less than 0.3 s in such a manner that the admixed liquid is essentially homogeneously distributed in the gas stream.

22. The method according to claim 21, wherein the admixed hydrogen-peroxide-comprising liquid is mixed with the dry gas stream in the course of less than 0.03 s in such a manner that the admixed liquid is essentially homogeneously distributed in the gas stream.

23. The method according to claim 21, wherein the admixed liquid at least partially evaporates in the gas stream.

24. The method according to claim 21, wherein the admixed liquid comprises 20 to 60% by weight of hydrogen peroxide and 40 to 80% by weight of water.

25. The method according to claim 21, wherein, in addition, sulfuric acid is added to the gas stream.

26. The method according to claim 25, wherein the sulfuric acid is present in the hydrogen-peroxide-comprising liquid.

27. The method according to claim 25, wherein the hydrogen-peroxide-comprising liquid and the sulfuric acid are added separately to the gas stream.

28. The method according to claim 27, wherein in the case of separate addition of the sulfuric acid and the hydrogen-peroxide-comprising liquid, the atomizing nozzles are arranged in such a manner that the spray cones mix with one another.

29. The method according to claim 21, wherein the amount of the added hydrogen peroxide is equivalent to 1.0 to 2.5 times the stoichiometrically required amount for converting all of the sulfur dioxide present in the gas stream.

30. The method according to claim 21, wherein the sulfuric acid formed in the reaction of sulfur dioxide with hydrogen peroxide is separated off from the gas stream in a filter or aerosol separator.

31. The method according to claim 21, wherein the gas stream, after addition of the hydrogen-peroxide-comprising liquid, is passed through a turbulence generator.

32. The method according to claim 21, wherein the dry sulfur-dioxide-comprising gas stream, upstream of the addition of the hydrogen-peroxide-comprising liquid, flows through an absorber packing, in which sulfur trioxide, which may be additionally present, is removed from the gas stream.

33. The method according to claim 21, wherein the velocity of the gas stream is increased upstream of the addition of the hydrogen-peroxide-comprising liquid.

34. The method according to claim 33, wherein the increase of the velocity is generated by a constriction of the flow cross-sectional area.

35. An apparatus for removing sulfur dioxide from a dry gas stream by a process according to claim 1, which comprises at least one atomizing nozzle for adding the hydrogen-peroxide-comprising liquid, and a filter or aerosol separator, arranged downstream, in the direction of flow of the gas stream, of the at least one atomizing nozzle, in each case at least one atomizing nozzle being arranged on a cross-sectional area of 300 to 350 cm².

36. The apparatus according to claim 35, wherein the flow cross-sectional area in the region of the at least one atomizing nozzle is smaller than the flow cross-sectional area at the gas inlet point.

37. The apparatus according to claim 36, wherein the flow cross-sectional area decreases continuously in the direction of flow from the gas inlet point up to the at least one atomizing nozzle.

38. The apparatus according to claim 35, wherein the flow cross-sectional area increases continuously or in the form of a sudden expansion in the direction of flow upstream of the filter or aerosol separator.

39. The apparatus according to claim 35, wherein one turbulence generator is connected downstream of the at least one atomizing nozzle.

40. The apparatus according to claim 39, wherein the turbulence generator is arranged in the region of the smallest cross-sectional area in the direction of flow upstream of the filter or aerosol separator.
